(19) United States
(12) Patent Application Publication
(10) Pub. No.: US 2023/0040040 A1
(43) Pub. Date: Feb. 9, 2023

(54) METHOD AND DEVICE FOR MONITORING A WORKING PROCESS

(71) Applicant: Fronius International GmbH, Pettenbach (AT)

(72) Inventors: Helmut ENNSBRUNNER, Pettenbach (AT); Manfred WITTMANN, Pettenbach (AT)

(73) Assignee: Fronius International GmbH, Pettenbach (AT)

(21) Appl. No.: 17/787,086

(22) PCT Filed: Dec. 17, 2020
(86) PCT No.: PCT/EP2020/086597

§ 371 Date: Jun. 17, 2022

(30) Foreign Application Priority Data
Dec. 19, 2019 (EP) 19218133.7

(51) Int. Cl. B25J 9/16

(52) U.S. Cl. CPC B25J 9/1676

(57) ABSTRACT

A method and a device monitors a working process, in which a workpiece is worked continuously along each of at least one working path during at least one working time period using a working tool arranged on a collaborative robot. The device includes a sensor apparatus for monitoring the environment of the collaborative robot and a detection device for detecting an object in a manipulation region around each working path of the collaborative robot. A working machine has a monitoring device of this type. The detection device is connected to a device for emitting an instruction signal within an instruction phase in the event that an object is detected in the manipulation region of a working path of the collaborative robot, so that the working process can be continued along the at least one working path without interruption.

The invention relates to a method for monitoring a working process, in which a workpiece is worked continuously along each of at least one working path during at least one working time period by means of a working tool arranged on a collaborative robot, wherein the environment of the collaborative robot is monitored and an object in a manipulation region around each working path of the collaborative robot is detected.

The invention further relates to a device for monitoring a working process, in which a workpiece can be worked continuously along each of at least one working path during at least one working time period by means of a working tool arranged on a collaborative robot, said device comprising a sensor apparatus for monitoring the environment of the collaborative robot, and a detection device for detecting an object in a manipulation region around each working path of the collaborative robot.

Finally, the invention is also directed to a working machine, in particular a welding device, comprising a collaborative robot for the continuous working of a workpiece during at least one working time period along at least one working path.

An industrial robot which operates together with humans and is not separated therefrom by protective arrangements in the working process is designated as a collaborative robot or so-called cobot. The safety-related requirements for the collaborative robots are defined in corresponding standards and make provision that for the protection of the humans, collisions between robot and human are prevented. For this purpose, the robots have corresponding sensors, in which in the case of particular sensor signals a switching-off of the robots occurs automatically. For example, U.S. Pat. No. 5,952,796 A describes such a collaborative robot.

Methods for the planning of working processes in which collaborative robots are involved, in order on the one hand to be able to achieve maximum working speeds, and on the other hand to keep the risk of injury as low as possible for people who are involved, are described in the prior art, for example in WO 2015/049207 A2.

US 2015/0112483 A1 and US 2018/0297201 A1 describe manipulation methods in which pallets are loaded by means of a robot and particular zones in the region of the robot are monitored. This prior art does not concern working processes on a workpiece, nor is a collaborative robot used, which can cooperate with humans without safety precautions.

In working processes where the movement of the collaborative robot is part of the working process, the protective measures of the collaborative robots described above are not able to be applied in a problem-free manner. The standard protective measure of the collaborative robot is a stopping of the movement, which amounts to an interruption of the working process, which has a negative effect on the manufacturing quality. Examples of such working processes in which the movement of the collaborative robot is part of the manufacturing process, are welding- or soldering methods, painting methods, gluing methods, surface treatment methods, to name a few examples. During the working process, in addition or instead of the collaborative robot, the workpiece can also be moved in an accordingly controlled manner and does not necessarily have to be stationary. On a movement of the workpiece, the apparatus which brings about the movement of the workpiece is subject to the same rules as a collaborative robot.

The present invention relates to such working processes in which over at least one working time period predetermined working paths are to be respectively worked continuously and, for as high a working quality as possible, the working of these working paths is not to be interrupted during the working time periods. The formation of one or more weld seams on the workpiece is mentioned as an example of such a working process. If the continuous working of a working path, for example the formation of a weld seam, were interrupted by the automatic switching-off of the collaborative robot, the working would have to be resumed at the site of the interruption, which could lead to a loss of quality or even to a rejection of the workpiece.

The object of the present invention consists in the creation of an above-mentioned method and of an above-mentioned device for monitoring a working process and a working machine comprising such a monitoring device, by which the working process runs as free of interruption as possible. Disadvantages of known methods are to be reduced or prevented.

The problem according to the invention is solved as regard the method in that in the event that an object is detected in the manipulation region of a working path of the collaborative robot, an instruction signal is emitted within an instruction phase, and the working process is continued. The present invention makes provision that it is promptly detected whether an object is present in the manipulation region of a working path of the collaborative robot, so that steps can be taken promptly before an automatic switching-off of the collaborative robot, in order to remove the object from the manipulation region, the object, in so far as this concerns a human, can move away from the manipulation region or to re-plan the working accordingly, so that the detected object no longer constitutes an obstacle for the collaborative robot and thus the working process can be continued. All objects or persons with which parts of the collaborative robot could collide fall under the term “object”. The term “manipulation region” is understood to mean the region in relation to the working path of the collaborative robot within which collisions are possible during the working process. Depending on the type of collaborative robot, this can concern here a small region around the working path and also a larger region which also takes into consideration the axes of the robot and the movement possibilities thereof. Through the emission of an instruction signal according to the invention in the event of detection of an object in the manipulation region of a working path, it can thus be achieved that the object is moved promptly out from the manipulation region, or the working is altered accordingly, so that a continuation of the working process can be guaranteed. If the measures for removal of the object or re-planning of the working process were to fail, the usual protective measures, therefore generally a stopping of the movement of the robot, are of course carried out as hitherto to fulfill the corresponding standards and to prevent endangering the personnel or a damage to the working machines or to the workpiece. A change or a re-planning of the working process can take place in various ways, for example through the working of the same working path in the manipulation region of which the object was detected, with different movements of the robot or by changing the sequence of the working of the working paths, in so far as the working process comprises several working paths. The detection of the object in the manipulation region of a working path can take place through a wide variety of sensors and apparatus, which are arranged either on the collaborative robot or are placed at suitable locations.

In the event of the detection of an object in the manipulation region of a working path, an alarm can be emitted for example as instruction signal. Persons who are involved are made aware, through the alarm, that an object is situated in the manipulation region of a working path, whereby they are prompted to a removal of the object or the setting of different measures. The alarm is preferably emitted in the form of an acoustic, visual and/or tactile alarm. The various types of alarm can take place alternatively or cumulatively and are preferably emitted in the region of the working process or respectively of the working paths, so that corresponding measures can be taken for removing the detected object. Additionally or alternatively thereto, however, the alarms can also be communicated at locations which are remote from the working process, such as e.g. a monitoring centre of a processing hall, or else for documentation purposes.

In the event of the detection of an object in the manipulation region of a working path of the collaborative robot, alternatively or additionally to the alarm as instruction signal a corresponding command signal can also be emitted to the collaborative robot for changing or re-planning the working process. Thereby, the collaborative robot is automatically prompted to carry out a re-planning of the working when an object is situated in the manipulation region of a working path. As already briefly mentioned above, the change or re-planning of the working process can take place in a variety of ways.

In the event of the working of several working paths during the working process, the re-planning can be realized by a change of the sequence of the working paths. Thereby, a working path which is blocked by a detected object can be worked later, in the hope that the object was removed in the meantime or respectively has moved from the manipulation region of this working path. In so far as the detected object is situated in a part of the manipulation region which can be bypassed through a corresponding re-planning of the collaborative robot, this represents another possibility of a change to the working process. For example, a multi-axis robot can work the working path from a direction which is changed from that which was originally planned.

In accordance with the emitted command signal in the event of the detection of an object in the manipulation region of a working path of the collaborative robot, the working of the workpiece can also be continued with reduced working speed along at least one working path. This option is merely to prevent a possible collision of the robot with the object, in so far as other measures such as the changing or re-planning of the working process or the removing of the object from the manipulation region fail. Depending on the working process, a reduction of the working speed can namely also have a negative effect on the manufacturing quality.

The emitted instruction signal can be adapted to the type of detected object. Through this provision, information concerning the type of detected object can be conveyed in the emitted instruction signal. For example, the sound intensity of an acoustic alarm or light intensity of a visual alarm or intensity of a tactile alarm as instruction signal can be adapted to the size of an object. Subject to corresponding detection devices such as e.g. automatic image processing systems, corresponding information describing the type of object can also be emitted acoustically or visually, so that the corresponding operating personnel receives information about which object is concerned (for example a tool lying on the working path or a person situated in the vicinity of the working path).

The emitted instruction signal can be adapted, furthermore, to the position and/or the location of the detected object. As the position and/or the location of the detected object has an influence on the possible change or re-planning of the working process, a consideration in the emitted command signal as instruction signal is also of great importance. When an object is situated directly on the working path, a change of the working process can only exist through temporary change of the sequence of the working paths, whereas an arrangement of an object in the vicinity of the working path can be carried out by changing the angle of attack of the robot, without the working of this working path having to be carried out later. For example, a robot can work the working path from the opposite side, in so far as a personnel is situated as an object on the other side of the working path.

Immediately before an imminent collision of the collaborative robot with the detected object, the working of the workpiece is preferably stopped in a controlled manner. Through this measure, a damage to the working machine or to components thereof and to the workpiece which is to be worked is prevented and a later continuation of the working process is facilitated. For example, before an imminent collision of the robot with the detected object, a welding process can be terminated through suitable welding parameters and not merely through sudden switching-off of the welding current source. Thereby, a continuation of the welding of the weld seam could be made possible without or without substantial loss of quality. This is likewise conceivable in the case of other working processes.

The problem according to the invention is also solved by a device, mentioned above, for monitoring a working process in which the detection device is connected to a device for emitting an instruction signal within an instruction phase in the event of the detection of an object in the manipulation region of a working path of the collaborative robot. As already mentioned, the monitoring device can be integrated in the collaborative robot or can also be situated at a location remote therefrom or respectively at locations remote therefrom, by which an optimum detection of objects in the manipulation region of the working paths is possible. It is important here that the detection of the object is recognized in the manipulation region of the working path of the collaborative robot in an accordingly anticipatory manner, therefore as long as possible before an imminent collision of the robot with the object. The parts of the monitoring device, such as the sensor apparatus, detection device and device for emitting an instruction signal, can also be arranged at different and correspondingly suitable positions. With regard to the advantages which are able to be achieved by the monitoring device of the working process, reference is to be made to the description of the method for monitoring the working process.

The device for emitting an instruction signal can be formed by an alarm device for emitting an alarm.

Alternatively or additionally to this, the device for emitting an instruction signal can also be formed by a device for emitting a command signal to the collaborative robot for the re-planning of the working process.

The alarm device can be formed by a loudspeaker, a visual display and/or a vibration device. Different types of alarms and alarm devices can have advantages, depending on the working process. For example, in the case of very loud working processes, a visual or tactile alarm will have advantages compared to an acoustic alarm. The alarm device can be placed at correspondingly suitable positions, for example also directly in an apparatus which is worn on the body of member of the operating personnel, such as e.g. headphones, a wristband, a welding helmet, smart glasses or many others.

When the detection device is connected wirelessly to the device for emitting an instruction signal, the alarm can be transmitted to remote locations without intrusive wire connections.

According to a further feature of the invention, the detection device is connected to an interface for connecting to the collaborative robot. Through the connection between monitoring device and collaborative robot, a change and re-planning of the working process is made possible in particular limits, whereby a continuation of the working process can be guaranteed and thereby the manufacturing quality can not be impaired. A wide variety of standardized interfaces, such as e.g. CAN bus connections or suchlike, come into consideration as interfaces. The interfaces can serve for wired or wireless connection.

When the detection device is connected to a database, which database comprises various instruction signals depending on the type and/or the position and/or location of the detected object, targeted instruction signals (alarms and/or command signals to the collaborative robot) can be emitted. For example, for different objects, e.g. particular tools or persons as objects, suitable information of the database can be entered which is reproduced as an alarm or command signal on detection of these objects. For example, the alarm that a pair of pliers is situated on the working path can be emitted acoustically or visually, whereby the operating personnel can be induced to remove this rapidly from the working path, so that the working process can be continued without interruption. In addition to image processing methods, other physical methods which, for example, determine the material of the object, can also come into use.

The sensor apparatus can be formed for example by at least one camera. This constitutes a suitable realization of the sensor apparatus. Normal cameras, high-speed cameras, depth cameras which can also establish the position of the object in three-dimensional space, come into consideration as camera. Furthermore, other sensors such as e.g. ultrasonic transmitters and -receivers, radar systems, LIDAR (Light Detection and Ranging) systems, also come into consideration.

When a device for removing a detected object is provided, an automated removal or a removal attempt can also take place. Depending on the working process and depending on the detected object, such devices can be configured in a variety of ways, for example in the form of a compressed air device which can remove smaller objects by compressed air, up to pushers which push the objects out from the manipulation region, up to gripper systems which grasp the objects and remove them from the manipulation region.

The problem according to the invention is also solved by a working machine, in particular a welding device, comprising a collaborative robot, for the continuous working of a workpiece during at least one working time period along at least one working path, which comprises a monitoring device described above. Through a working machine equipped with a monitoring device according to the invention, an interruption of the working process by automatic switching-off of the collaborative robot can be prevented or respectively the frequency thereof can be at least reduced and thus the cycle time in the working of the workpieces can be increased and the wastage through workpieces of inferior quality can be reduced. With regard to the further advantages, reference is to be made to the above description of the monitoring method and of the monitoring device.

The present invention is explained more closely with the aid of the enclosed drawings. There are shown therein:

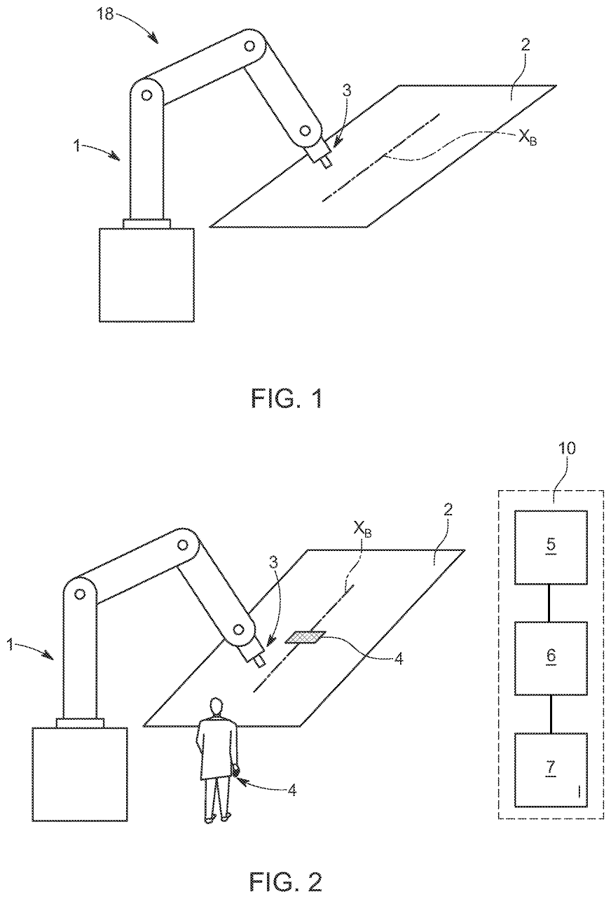

FIG. 1 a schematic diagram of a working machine for carrying out a working process;

FIG. 2 a block diagram of a monitoring device according to the invention for monitoring a working process;

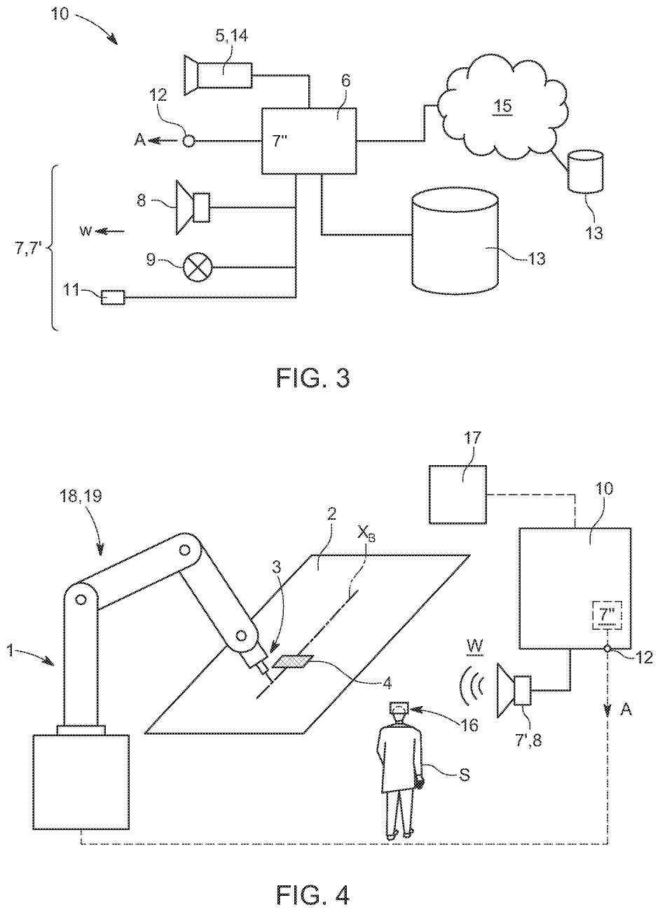

FIG. 3 an embodiment of a monitoring device for monitoring a working process;

FIG. 4 a further embodiment of a monitoring device integrated in a welding robot;

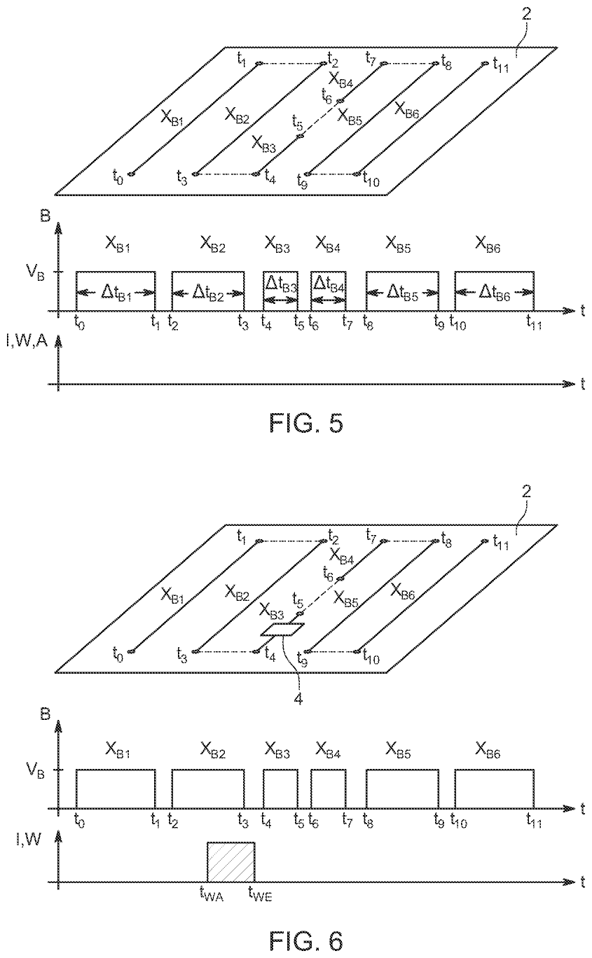

FIG. 5 a working process consisting of several working paths, during which no object was detected in the manipulation region;

FIG. 6 the working process according to FIG. 5, wherein an object was detected in the manipulation region of a working path and a corresponding alarm is emitted as instruction signal;

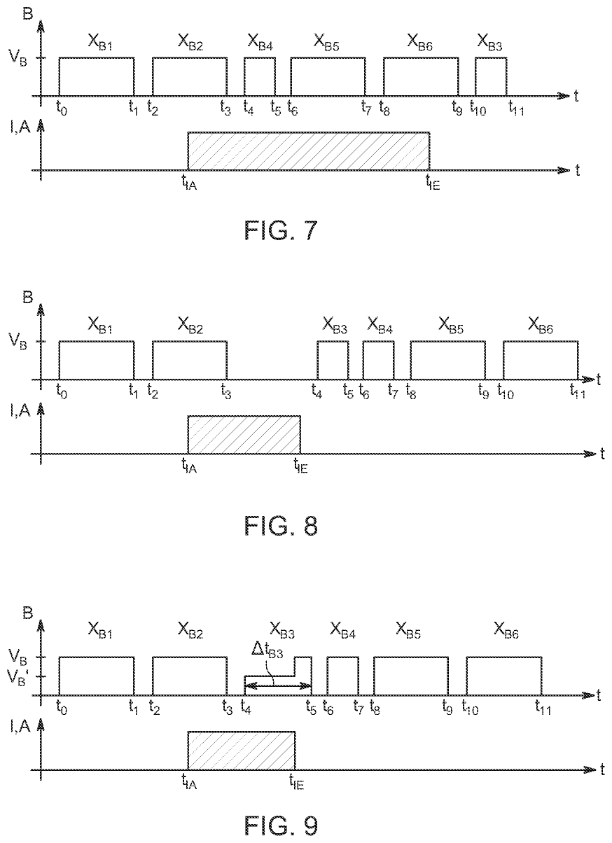

FIG. 7 a variant of the working process according to FIG. 6, wherein an object was detected in the manipulation region of a working path and corresponding to a command signal as instruction signal a re-planning of the working takes place;

FIG. 8 a further variant of the working process according to

FIG. 6, wherein an object was detected in the manipulation region of a working path and corresponding to a command signal as instruction signal the working process is re-planned; and

FIG. 9 a further variant of the working process according to FIG. 6, wherein an object was detected in the manipulation region of a working path and corresponding to a command signal as instruction signal the working of a working path is continued at reduced speed.

FIG. 1 shows a schematic diagram of a working machine 18 for carrying out a working process in which a workpiece 2 is worked by means of a working tool 3, arranged on a collaborative robot 1, during at least one working time period Δt_{Bi} along at least one working path x_{Bi}. In the simplest case, a working path x_{B} is worked during a working time period Δt_{B}, for example a weld seam is produced along a working path x_{B}. In addition to such simple working processes, conventional working processes comprise the working of several working paths x_{Bi} at several working time periods Δt_{Bi}, wherein, between the working of the individual working paths x_{Bi}, pauses are inserted in which the collaborative robot 1 is re-positioned, tools are changed or working parameters are altered. The present invention relates to working processes in which an interruption of the working of a working path x_{Bi} leads to changes of the manufacturing quality and, in certain circumstances, the tool 2 even has to be rejected thereby. Welding methods, soldering methods, painting methods, surface treatment methods, for example by means of plasma jets, and many more, are named as examples of such working processes. As already mentioned above, additionally or alternatively to the collaborative robot 1, the workpiece 2 can also be moved with a corresponding apparatus (not illustrated).

FIG. 2 shows a block diagram of a monitoring device 10 according to the invention for monitoring a working process. The monitoring device 10 contains a sensor apparatus 5 for monitoring of the environment of the collaborative robot 1 or respectively at least of the manipulation region around the working path x_{B} of the collaborative robot 1. A detection device 6 is connected to the sensor apparatus 5, which detection device detects objects 4 in a manipulation region around each working path x_{B} of the collaborative robot 1. Objects 4 can concern for example items on the working path x_{B}, in the vicinity of the working path x_{B} or persons in the manipulation region. Connected to the detection device 6 is a device 7 which, in the event of the detection of an object 4 in the manipulation region of a working path x_{B}, emits an instruction signal I. The emitted instruction signal I of the device 7 can be an alarm W, whereby an operating personnel can be made aware of the detection of an object 4 and can be prompted to remove the object 4 within an instruction phase Δt_{I}. Additionally or alternatively thereto, a command signal A can also be emitted to the collaborative robot 1 as instruction signal I for the re-planning of the working process. The command signal A can arrive in various ways (wireless or wired) to the collaborative robot 1, where for example a decision can be made with the aid of stored alternative working processes, whether a change or respectively re-planning of the working process is possible. In so far as the object 4 can not be successfully removed from the manipulation region or that the working process can not be successfully changed or re-planned within this instruction phase Δt_{I}, the usual standard protective measures of the collaborative robot 1 are initiated and usually a stopping of the movement of the robot occurs and thus a termination of the working process. Through the instruction signal I, which is emitted by the device 7 when an object 4 is detected in the manipulation region of the working path x_{B}, the possibility exists, however, to take measures in order to be able to continuously proceed with the working process or at least individual working paths x_{Bi}. Thereby, the quality of the working process and thus of the worked workpiece 2 can be increased and a rejection can be prevented.

FIG. 3 shows an embodiment of a monitoring device 10 for monitoring a working process. The monitoring device 10 contains a sensor apparatus 5 which can be formed for example by a camera 14. The sensor apparatus 5 is connected to the detection device 6 for example at an image processing device for the processing of the images which are captured with the camera 14. The device 7 for emitting an instruction signal I is formed here by an alarm device 7′ for emitting an alarm W. For example, a loudspeaker 8, a visual display 9 or a vibration device 11 can be provided as alarm device 7′, which can be used optionally or cumulatively. In addition to directly connected alarm devices 7′, various alarm devices 7′ can also be connected wirelessly to the detection device 6 (not illustrated). The detection device 6 of the monitoring device 10 can have an interface 12 for connection to the collaborative robot 1, via which a command signal A of a device 7″ can be emitted to the collaborative robot 1 (not illustrated) for re-planning the working process. Further interfaces (not illustrated) for connection to other components involved in the working process are also conceivable.

A database 13 which contains various alarms W or command signals A as a function of the type and/or the position and/or the location of detected objects 4, can be connected to the detection device 6. Thereby, as a function of the type, position or location of the detected object 4, a different instruction signal I of the device 7 can be emitted. The database 13 can also be connected to the detection device 6 via a network 15, in particular the internet.

FIG. 4 shows a further embodiment of a monitoring device 10 which is integrated in a welding robot. In this example embodiment, a welding torch is arranged as working tool 3 on the collaborative robot 1, or respectively the welding device 19 is integrated in the collaborative robot 1. In the illustrated example embodiment, the monitoring device 10 is situated remote from the welding device 19, but can also be integrated therein. An alarm device 7′ in the form of a loudspeaker 8 is provided as part of the monitoring device 10 or else externally, which alarm device emits an alarm W on detection of an object 4 in the manipulation region of the working path x_{B}. The alarm W can also be emitted to a welder S for example in the form of a visual alarm W to the head-up display of a welding helmet 16. The welder S is thereby prompted to remove the object 4 from the manipulation region of the working path x_{B}, so that the working process can be continued. The connection of a device 17 for removing a detected object 4 with the monitoring device 10, which removing device 17 automatically removes the detected object 4 out of the manipulation region of the collaborative robot 1 is also conceivable. A device 7″ for emitting a command signal A to the collaborative robot 1 as further instruction signal I can be provided as a further part of the monitoring device 10. The command signal A can be transmitted to the collaborative robot 1 via an interface 12 of the monitoring device 10, in order to be able to change or re-plan the working process on detecting an object 4. On a change of the working process it is important that in the event of the change of the access of the collaborative robot 1 with respect to the working path x_{B}, the TCP (Tool Centre Point) remains the same, so that a working of the working path x_{B} can be guaranteed with the same quality.

FIG. 5 shows working process consisting of several working paths x_{B1} to x_{B6}, during which no object 4 was detected in the manipulation region. Six working paths x_{B1} to x_{B6}, which are worked one after the other, are situated on the workpiece 2. Accordingly, the working B takes place beginning with time t₀ with the working of the first working path x_{B1}. which takes place during the working duration Δt_{Bi} with a working speed v_{B} up to the time t₁. After a pause, the working of the working path x_{B2} is begun at the time t₂, which is terminated at the time t₃. After termination of the working of the working path x_{B6} at the time t₁₁, the working process is completed. Since no object 4 is situated in the manipulation region of a working path x_{B1} to x_{B6}, also no instruction signal I is emitted in the form of an alarm W or of a command signal A during the working duration.

FIG. 6 shows the working process according to FIG. 5, wherein an object 4 was detected in the manipulation region of a working path, here the working path x_{B3}. The working B is begun with working of the working path x_{B1} and is continued with the working of the working path x_{B2}. Promptly before the working of the working path x_{B3}, an object 4 is detected by the detection device 6 in a working path, here in the working path x_{B3} and an alarm W is promptly emitted as instruction signal I. The alarm W is begun at a time t_{WA} and is emitted until the object 4 has been removed. In the illustrated example embodiment, the end of the alarm W takes place at the time t_{WE}, whereupon the working process is continued with the working of the working path x_{B3} and can be ended according to plan, as in the case of the working according to FIG. 5.

FIG. 7 shows a variant of the working process according to FIG. 6, wherein an object 4 was detected in the manipulation region of the working path x_{B3} and in accordance with a command signal A as instruction signal I a re-planning of the working process takes place. In this example embodiment, a re-planning of the working takes place by the sequence of the working paths x_{Bi} being changed. In the illustrated example embodiment, after the working of the working path x_{B2} at the time t₄ the working of the working path x_{B4} is continued, thereafter the working of the working path x_{B5} and the working of the working path x_{B6} is carried out. During the working of the working path x_{B6}, the detected object 4 is removed at time t_{IE} from the manipulation region, whereby the emission of the instruction signal I or respectively command signal A is stopped. Thereafter, the working with the working path x_{B3} is completed in changed sequence. As long as the object 4 is detected in the manipulation region, the emission of the instruction signal I or respectively command signal A takes place (between the times t_{IA} and t_{IE}).

FIG. 8 shows a further variant of a working process, wherein an object 4 was detected in the manipulation region of the working path x_{B3} and in accordance with a command signal A to the collaborative robot 1 a re-planning of the working process takes place. In contrast to the example embodiment according to FIG. 7, a re-planning of the working process does not take place here through changing of the sequence of the working paths x_{Bi}, but rather through lengthening the pause between the working of the working path x_{B2} and working of the working path x_{B3}, until the object 4 has been successfully removed from the working path x_{B3} or respectively its manipulation region. In the illustrated example embodiment, an object 4 is detected in the manipulation region between the times t_{IA} and t_{IE}. At the time t_{IE} the removal of the object 4 from the working path x_{B3} takes place and the emission of an instruction signal I or respectively command signal A thus ends. Thereafter, at the time t₄ the working of the working path x_{B3} can be continued and the working can be completed according to plan up to the working of the working path x_{B6}. In this variant, the working duration as a whole is indeed increased, however no interruption of the working of the individual working paths x_{Bi} takes place during the working time periods Δt_{Bi}, whereby the quality of the working is not negatively influenced.

In FIG. 9 a further variant of the working process according to FIG. 6 is illustrated, wherein an object 4 was detected in the manipulation region of the working path x_{B3} and in accordance with a command signal A as instruction signal I the working of a working path is continued with reduced speed. Here, after the detection of an object 4, the working which is currently being carried out, here the working of the working path x_{B2}, is completed, and thereafter the working of the working path x_{B3}, in the region of which the object 4 was detected, is carried out with reduced speed v_{B}′ compared to the normal working speed v_{B}, whereby the working time period Δt_{B3} of the working of the working path x_{B3} is lengthened and thus more time is created in order to remove the object 4 from the working path x_{B3} or to change the movement of the collaborative robot 1. When at the time t_{IE} the object 4 is no longer detected, the working of the workpiece 2 with working of the working path x_{B3} with normal working speed v_{B} can be ended and with the working of the further working paths x_{B4} and x_{B5} can be continued and finally completed with the working of the working path x_{B6}. Also in this variant of the working method, the total duration of the working is increased compared to the variant according to FIG. 5 and it is nevertheless guaranteed that the workings of the individual working paths x_{Bi} can be carried out without interruption continuously during the working time periods Δt_{Bi}.

The present invention guarantees a carrying out of a working process with uninterrupted working of the working path or respectively working paths, without the quality of the worked workpiece 2 being impaired.

1. A method for monitoring a working process, in which a workpiece (2) is worked continuously along each of at least one predetermined working path (x_{Bi}) on the workpiece (2) during at least one working time period (Δt_{Bi}) by means of a working tool (3) arranged on a collaborative robot (1), wherein the environment of the collaborative robot (1) is monitored and an object (4) in a manipulation region of the collaborative robot (1) around one of the predetermined working paths (x_{Bi}) on the workpiece (2) is detected, wherein in the event that an object (4) is detected in the manipulation region of the collaborative robot (1) around one of the predetermined working paths (x_{Bi}) on the workpiece (2) within an instruction phase (Δt_{I}) an instruction signal (I) is emitted and the working process is continued along one of the predetermined working paths (x_{Bi}) on the workpiece (2) without interruption, for as high a manufacturing quality as possible.

2. The method according to claim 1, wherein an alarm (W), preferably in the form of an acoustic, visual and/or tactile alarm (W), is emitted as instruction signal (I).

3. The method according to claim 1, wherein a command signal (A) is emitted as instruction signal (I) to the collaborative robot (1) for the re-planning of the working process.

4. The method according to claim 3, wherein in accordance with the emitted command signal (A) in the event of the detection of an object (4) in the manipulation region around one of the predetermined working paths (x_{Bi}) of the collaborative robot (1) the working process is changed by preferably the sequence of predetermined the working paths (x_{Bi}) being altered.

5. The method according to claim 3, wherein in accordance with the emitted command signal (A) in the event of the detection of an object (4) in the manipulation region around one of the predetermined working paths (x_{Bi}) of the collaborative robot (1), the working of the workpiece (2) is continued at reduced working speed (v_{B}′) along at least one of the predetermined working paths (x_{Bi}).

6. The method according to claim 1, wherein the emitted instruction signal (I) is adapted to the type and/or the position and/or location of the detected object (4).

7. The method according to claim 1, wherein immediately before an imminent collision of the collaborative robot (1) with the detected object (4), the working of the workpiece (2) is stopped in a controlled manner.

8. A device (10) for monitoring a working process, in which a workpiece (2) can be worked continuously along each of at least one predetermined working path (x_{Bi}) on the workpiece (2) during at least one working time period (Δt_{Bi}) by means of working tool (3) arranged on a collaborative robot (1), said device comprising a sensor apparatus (5) for monitoring the environment of the collaborative robot (1) and a detection device (6) for detecting an object (4) in a manipulation region of the collaborative robot (1) around one of the predetermined working paths (x_{Bi}) on the workpiece (2), wherein the detection device (6) is connected to a device (7) for emitting an instruction signal (I) within an instruction phase (Δt_{I}) in the event that an object (4) is detected in the manipulation region of the collaborative robot (1) around one of the predetermined working paths (x_{Bi}) on the workpiece (2), so that the working process can be continued along one of the predetermined working paths (x_{Bi}) on the workpiece (2) without interruption, for as high a manufacturing quality as possible.

9. The device (10) according to claim 8, wherein the device (7) is formed for emitting an instruction signal (I) by an alarm device (7′) for emitting an alarm (W).

10. The device (10) according to claim 8, wherein the device (7) for emitting an instruction signal (I) is formed by a device (7″) for emitting a command signal (A) to the collaborative robot (1) for re-planning the working process.

11. The device (10) according to claim 9, wherein the alarm device (7′) is formed by a loudspeaker (8), a visual display (9) and/or a vibration device (11).

12. The device (10) according to claim 8, wherein the detection device (6) is connected wirelessly to the device (7) for emitting an instruction signal (I).

13. The device (10) according to claim 8, wherein the detection device (6) is connected to an interface (12) for connection to the collaborative robot (1).

14. The device (10) according to claim 8, wherein the detection device (6) is connected to a database (13), which database (13) comprises various instruction signals (I) as a function of the type and/or the position and/or the location of the detected objects (4).

15. A working machine (18), in particular a welding device (19), comprising a collaborative robot (1), for the continuous working of a workpiece (2) during at least one working time period (Δt_{B}) along at least one working predetermined path (x_{B}), wherein the monitoring device (10) according to claim 8 is provided.
